(19) United States
(12) Patent Application Publication
(10) Pub. No.: US 2022/0410380 A1
(43) Pub. Date: Dec. 29, 2022

(54) LEARNING ROBOTIC SKILLS WITH IMITATION AND REINFORCEMENT AT SCALE

(71) Applicant: X Development LLC, Mountain View, CA (US)

(72) Inventors: Yao Lu, Los Altos, CA (US); Mengyuan Yan, Stanford, CA (US); Seyed Mohammad Khansari Zadeh, San Carlos, CA (US); Alexander Herzog, San Jose, CA (US); Eric Jang, Cupertino, CA (US); Karol Hausman, San Francisco, CA (US); Yevgen Chebotar, Menlo Park, CA (US); Sergey Levine, Berkeley, CA (US); Alexander Irpan, Palo Alto, CA (US)

(21) Appl. No.: 17/843,288

(22) Filed: Jun. 17, 2022

Related U.S. Application Data
(60) Provisional application No. 63/212,026, filed on Jun. 17, 2021.

(51) Int. Cl. B25J 9/16

(52) U.S. Cl. CPC B25J 9/163; B25J 9/161

(57) ABSTRACT

Utilizing an initial set of offline positive-only robotic demonstration data for pre-training an actor network and a critic network for robotic control, followed by further training of the networks based on online robotic episodes that utilize the network(s). Implementations enable the actor network to be effectively pre-trained, while mitigating occurrences of and/or the extent of forgetting when further trained based on episode data. Implementations additionally or alternatively enable the actor network to be trained to a given degree of effectiveness in fewer training steps. In various implementations, one or more adaptation techniques are utilized in performing the robotic episodes and/or in performing the robotic training. The adaptation techniques can each, individually, result in one or more corresponding advantages and, when used in any combination, the corresponding advantages can accumulate. The adaptation techniques include Positive Sample Filtering, Adaptive Exploration, Using Max Q Values, and Using the Actor in CEM.

### BACKGROUND

Learning methods for optimal robotic control include reinforcement learning (RL) and imitation learning (IL). RL is based on autonomous trial-and-error methods and enables robots to improve with autonomously collected experience from robotic episodes. RL methods seek to find a policy (e.g., represented by neural network model(s)) that maximizes the expected discounted reward over trajectories that are induced by the policy.

However, RL learning methods can present various drawbacks, especially for large and/or continuous action spaces that are present in many robotic control scenarios. For example, RL learning methods can introduce significant challenges with exploration and/or stable learning. For instance, RL learning methods for continuous action spaces and/or complex robotic tasks can require hundreds of thousands of training steps before the policy begins to be effective (e.g., reach a success rate of above 10%, 20%, or other threshold) and/or can require millions of training steps for a robotic task before reaching desired effectiveness (e.g., a success rate of above 80%, 90%, or other threshold). Such a large quantity of training steps can require significant computational resources. Further, performing robotic episodes (real and/or simulated), needed to generate such a large quantity of episode data for training, can likewise require significant computational resources.

One example of an RL learning method is Q-learning. Q-learning can be used to train a neural network, representing a Q-function, to satisfy the Bellman equation. For example, in the robotics context, the neural network can be trained to process robotic state data (e.g., vision data and/or other sensor data) and a parameterization of a candidate robotic action, and to generate a Q-value that represents the expected discounted reward for taking the candidate robotic action, in view of the state. For instance, when used in robotic control, the neural network can be used, at each step, to process robotic state data and each of a plurality of candidate robotic actions (e.g., sampled using the cross-entropy method (CEM)), to generate a corresponding Q-value for each candidate robotic action. One of those candidate robotic actions can be selected, based on having the best Q-value, and implemented at the step.

IL is based on imitation of demonstrations and provides for more stable learning (relative to RL). The demonstrations can be user-provided or otherwise curated (e.g., scripted via human programming). With IL learning methods, instead of defining a reward function, the goal of the trained policy (e.g., represented by neural network model(s)) is to reproduce demonstrated behaviors, such as those demonstrated by a human. For example, demonstrations can be provided by a human through teleoperation or kinesthetic teaching. However, IL suffers from distributional shifts due to lack of online data collection, which can result in the IL trained policy performing poorly when deployed in the real world. Further, IL, standing alone, cannot exceed the level of proficiency in the demonstrations, which can result in inefficient and/or non-robust robotic interactions in various scenarios.

In view of the complementary strengths and weaknesses of RL and IL, techniques have been proposed that effectively combine RL and IL learning methods. Some of those techniques utilize an initial set of offline positive-only demonstration data for pre-training model(s), followed by later robotic episodes that utilize the model(s) and that generate episode data that can be used to fine-tune the pre-trained policy. Some of those techniques treat the demonstration data and episode data identically, and apply the same RL loss for both the demonstration data and the episode data. QT-Opt and the Advantage Weighted Actor Critic (AWAC) are two examples of such techniques.

Qt-Opt is one particular example of Q-learning, and is a distributed Q-learning framework that enables learning of Q-functions with continuous actions by maximizing the Q-function using a cross-entropy method (CEM) and without an explicit actor model.

The AWAC technique optimizes the following objective:

E_{s˜D}[E_{πθ}(s)[Q(s,a)]] s.t D_{KL}(π_{θ},π_{β})≤∈, (1)

In equation (1), a is an action, s is a state, D_{KL}(π_{θ},π_{β})≤∈ represents a KL-divergence constraint between the current policy π_{θ} and π_{β}, where π_{β} is a distribution that generated all the data so far. The closed form solution to this problem is given by:

$${π}_{θ}^{⋆} ( s ) = \frac{1}{Z ( s )} {π}_{β} ( s ) exp ( {A}^{{π}_{θ}^{⋆}} ( s , a ) ) , \qquad ( 2 )$$

In equation (2), A is the advantage function, Z(s) is the normalizing partition function and [symbol] is a hyper-parameter. Since the actor update in Eq. 2 samples and re-weights the actions directly from the previous policy π_{β}, it implicitly constraints the resulting distribution to the KL-divergence term.

However, QT-Opt, AWAC, and/or other techniques suffer from one or more drawbacks. For example, with QT-opt and/or other Q-learning techniques, initializing a neural network model, that represents a Q-function, by pre-training based on demonstration data can result in the neural network model generating over-optimistic Q-values on state-action pairs that are unseen in the demonstration data. This results in a poorly initialized neural network model and it can still require a significant quantity of further training of the neural network model, based on episode data, before reaching desired effectiveness. For example, it can still require the same amount (or near the same amount, or even a greater amount) of training steps than if the pre-training had not occurred. Through pre-training based on demonstration data, AWAC and/or other advantage-weighted techniques can initialize an actor neural network that begins to be effective. However, with AWAC and/or other advantage-weighted techniques, the actor network can suffer from catastrophic forgetting when further trained based on episode data. For example, for a complex robotic task, performance of the actor network can degrade as training based on episode data progresses, and may never recover even after hundreds of thousands of training steps.

### SUMMARY

Implementations disclosed herein relate to particular techniques for utilizing an initial set of offline positive-only robotic demonstration data for pre-training an actor network and a critic network, followed by further training of the networks based on online robotic episodes that utilize the network(s). Implementations enable the actor network to be effectively pre-trained, while mitigating occurrences of and/or the extent of forgetting when further trained based on episode data. For example, implementations can eliminate occurrences of catastrophic forgetting and can eliminate or lessen the extent of forgetting when further trained based on episode data. Implementations additionally or alternatively enable the actor network to be trained to a given degree of effectiveness in fewer training steps as compared to other techniques, thereby conserving computational resources utilized during training and/or utilized in generating episode data for training. Further, although the critic network is trained and is utilized in training of the actor network, implementations enable the actor network to be utilized, independent of the critic network, at inference time in control of robot(s) to perform robotic task(s) based on which the actor network was trained. Utilization of the actor network independent of the critic network provides for low-latency robotic control.

The actor network can be a first neural network model that represents a policy. The actor network can be used to process state data to generate output that indicates an action to be taken in view of the state data. The state data can include, for example, environmental state data (e.g., image(s) and/or other vision data captured by vision component(s) of a robot) and/or current robot state data (e.g., that indicates a current state of component(s) of the robot). The output can be, for example, a probability distribution over an action space. The action to be taken, based on the output of the actor network, can be the highest probability action, optionally subject to one or more rules-based constraints (e.g., safety and/or kinematic constraint(s)).

The critic network can be a second neural network model that represents a value function (e.g., a Q-function). The critic network can be used to process state data and a candidate action, and generate a measure (e.g., a Q-value) that represents the expected discounted reward for taking the candidate robotic action, in view of the state.

In pre-training the actor network and the critic network based on demonstration data and using RL (which approximates IL), implementations can pre-train the actor network using an advantage-weighted regression training objective such as AWAC. Further, implementations can pre-train the critic network using Q-learning and CEM (e.g., utilizing QT-opt techniques). Positive RL rewards, optionally discounted based on discount factor(s), can be utilized in the pre-training as the demonstrations are all successful/positive demonstrations. The demonstration data can be based on demonstration episodes. Demonstration episodes can be guided by humans (human demonstration episodes) or can be scripted demonstration episodes that are guided by a human written program or script.

It is noted that the advantage-weighted regression training objective utilizes the critic network in calculating the advantage. Put another way, the advantage generated in the advantage-weighted regression training objective is based on the Q-function that is represented by the critic network. For example, with AWAC and as represented by equation (1), Q(s, a) represents the Q-value (generated based on the current critic network) for the state data and the action indicated by the actor network.

In some implementations, training the critic network using Q-learning and CEM can include optimizing the Bellman optimality equation using the cross-entropy method, which enables stable training of the Q-function. More formally, this is represented by:

$${π}^{⋆} ( s ) ∝ {π}_{β} ( s ) exp ( {A}^{{π}^{⋆}} ( s , a ) ) \qquad ( 3 )$$

$${A}^{{π}^{⋆}} ( s , a ) = {Q}_{C E M}^{{π}^{⋆}} ( s , a ) - {V}_{C E M}^{{π}^{⋆}} ( s , a ) , \qquad ( 4 )$$

In equations (3) and (4), variables have the same meaning as their use earlier (e.g., in equation (1) and (2) in the background and, in equation (4), Q_{CEM}^{π*}(s, a) is computed according to the Bellman optimality equation that is optimized using CEM:

Q_{CEM}^{π*}(s,a)=R(s,a)+γarg[Q^{π*}(s′,a′)]. (5)

After pre-training the actor and critic networks based on demonstration data, implementations further train the actor network and the critic network using RL and online (but potentially off-policy) episode data from robotic episodes each performed based on the actor network and/or the critic network. The RL episodes can include simulated episodes from robotic simulator(s) with robot(s) interacting with simulated environment(s) and/or real episodes from real robot(s) interacting with real environment(s).

During the further training, the actor network continues to be trained using an advantage-weighted regression training objective such as AWAC. Further, the critic network continues to be trained using Q-learning and CEM (e.g., utilizing QT-opt techniques).

In various implementations, one or more adaptation techniques are utilized in performing the robotic episodes and/or in performing the robotic training. The adaptation techniques can each, individually, result in one or more corresponding advantages and, when used in any combination, the corresponding advantages can accumulate. The adaptation techniques include Positive Sample Filtering, Adaptive Exploration, Using Max Q Values, and Using the Actor in CEM. Each of these adaptation techniques is addressed briefly in turn below. Some implementations can implement only one of these techniques in isolation, while other implementations can implement multiple (e.g., all) of these techniques in combination.

With Positive Sample Filtering, during at least a portion of the further training (e.g., at least an initial portion of the further training) the critic network is trained on a greater quantity of unsuccessful episode data with negative rewards (i.e., episode data from unsuccessful episodes) as compared to the quantity of episode data utilized in training the actor network. It is noted that the actor network can still be utilized in performing an unsuccessful episode despite the actor network not being trained based on episode data from the unsuccessful episode.

As one example, the actor network can be trained based solely on successful episode data with positive rewards (i.e., episode data from successful episodes). In such an example, the quantity of unsuccessful episode data on which the actor network is trained is zero. As another example, the actor network can be trained based on at least 99% successful episode data and 1% or less unsuccessful episode data, can be trained based on at least 95% successful episode data and 5% or less unsuccessful episode data, and/or other ratios. In the preceding examples, the critic network will be trained based on a greater quantity of unsuccessful episode data and negative rewards. For example, the critic network can be trained based on approximately (e.g., +/−15%) 50% unsuccessful episode data and 50% successful episode data. For instance, a prioritized replay buffer can be populated, with episode data, with an objective that 50% of sampled data for training the critic network comes from successful episodes and 50% comes from unsuccessful episodes. In such an instance, the actor network can be trained based on the 50% of sampled data from successful episodes, but not trained based on the 50% from unsuccessful episodes.

In various implementations, Positive Sample Filtering can prevent catastrophic forgetting by the actor network and/or can mitigate the extent of forgetting by the actor network.

With Adaptive Exploration, the exploration strategy utilized in performing the robotic episodes is adapted. In some implementations, the adaptation for at least some of the episodes can be on an episode-by-episode basis. Put another way, where the adaptation is between two exploration strategies, the entirety of a first set of episodes can utilize a first exploration strategy and the entirety of a remaining second set of the episodes can utilize a second exploration strategy. For example, the first set of episodes can include approximately 80% of the episodes and the second set of episodes can include approximately 20% of the episodes. In some additional or alternative implementations, the adaptation for at least some of the episodes can be on an intra-episode step-by-step basis. Put another way, where the adaptation is between two exploration strategies, a first set of steps of an episode can utilize a first exploration strategy and a remaining second set of steps of the episode can utilize a second exploration strategy. The steps of the first set can be sequential or nonsequential, as can the steps of the second set. For example, the first set of steps can include approximately 80% of the steps of the episode and the second set of steps can include approximately 20% of the steps of the episode.

One non-limiting example of an exploration strategy is a CEM policy in which CEM is performed, using the critic network and sampled actions, and results from the CEM are utilized in selecting an action. Another non-limiting example of an exploration strategy is a greedy Gaussian policy in which a probability distribution, generated using the actor network based on a corresponding state and corresponding to candidate actions, is utilized in selecting an action. Another non-limiting example of an exploration strategy is a non-greedy Gaussian policy in which a probability distribution, generated using the actor network, is still utilized in selecting an action—but in a non-greedy manner.

As described herein, episode data, from the robotic episodes, is used in RL training of the actor network and the critic network. In various implementations, training based on episode data generated using Adaptive Exploration can enable the actor network to achieve a higher success rate, with a given amount of training, as compared to training based on episode data not generated using Adaptive Exploration.

With Using the Actor in CEM, during training an action is predicted using the actor network and based on the episode data. That action is processed, along with current state data, using the critic network, to generate an actor action measure (e.g., Q-value) for the actor action. Further, the current state data and each of multiple candidate actions sampled using CEM, are also processed using the critic network (i.e., N current state data candidate action pairs), to generate a corresponding candidate action measure (e.g., Q-value) for each of the candidate actions. Instead of always using the maximum candidate action measure (e.g., Q-value) from CEM as the maximum value for training of the critic network (and optionally in the advantage function for training of the actor network) as is typical, Using the Action in CEM compares the actor action measure to the maximum candidate action measure—and uses the greater of the two measures as the maximum value for training.

In various implementations, Using the Actor in CEM during training, can enable the actor network to achieve a higher success rate, with a given amount of training, as compared to training without Using the Actor in CEM.

With Using Max Q Values, instead of utilizing an Expected Q value, in the advantage function for training of the actor network using the advantage-weighted regression training objective, a Max Q Value is utilized. Put another way, the Max Q Value can be utilized in training of the critic network, and can also be utilized as part of the advantage-weighted regression training objective in training the actor network (e.g., when it's being trained based on the Positive Sample Filtering referenced above).

In various implementations, Using Max Q Values during training can enable the actor network to achieve a higher success rate, with a given amount of training, as compared to training without Using the Actor in CEM.

The above description is provided as an overview of only some implementations disclosed herein. These and other implementations are described in more detail herein, including in the detailed description, the claims, and in the appended paper.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a flowchart illustrating an example method of pre-training an actor network and a critic network based on offline demonstration data, according to various implementations disclosed herein.

FIG. 2 is a flowchart illustrating an example method of generating online episode data, according to various implementations disclosed herein.

FIG. 3 is a flowchart illustrating an example method of further training an actor network and a critic network based on online episode data, according to various implementations disclosed herein.

FIG. 4 schematically depicts an example architecture of a robot.

FIG. 5 schematically depicts an example architecture of a computer system.

### DETAILED DESCRIPTION

Implementations disclosed herein relate to particular techniques for utilizing an initial set of offline positive-only robotic demonstration data for pre-training an actor network and a critic network, followed by further training of the networks based on online robotic episodes that utilize the network(s). The online robotic episodes, that utilize the network(s) can include those performed by real physical robot(s) in real environment(s) and/or those performed by robotic simulator(s) in simulated environment(s). The actor network and/or the critic network can be trained to perform one or more robotic task(s), such as those that involve manipulating object(s). For example, the task(s) can include pushing, grasping, or otherwise manipulating one or more objects. As another example, the task can include a more complex task such as loading each of multiple objects into a dishwasher or picking object(s) and placing each of them into an appropriate area (e.g., into one of a recycling bin, a compost bin, and a trash bin).

Techniques disclosed herein can be utilized in combination with various real and/or simulated robots, such as a telepresence robot, a wheeled robot, mobile forklift robot, a robot arm, an unmanned aerial vehicle (“UAV”), and/or a humanoid robot. The robot(s) can include various sensor component(s) and state data that is utilized in techniques disclosed herein can include sensor data that is generated by those sensor component(s) (e.g., images from a camera and/or other vision data from other vision component(s)) and/or can include state data that is derived from such sensor data (e.g., object bounding box(es) derived from vision data). As a particular example, a robot can include vision component(s) such as, for example, a monographic camera (e.g., generating 2D RGB images), a stereographic camera (e.g., generating 2.5D RGB-D images), and/or a laser scanner (e.g., LIDAR generating a 2.5D depth (D) image or point cloud). A robot can additionally optionally include arm(s) and/or other appendage(s) with end effector(s), such as those that take the form of a gripper. Additional description of some examples of the structure and functionality of various robots is provided herein.

Robotic simulator(s), when utilized in techniques disclosed herein, can be implemented by one or more computing devices. A robotic simulator is used to simulate an environment that includes corresponding environmental object(s), to simulate a robot operating in the simulated environment, to simulate responses of the simulated robot in response to virtual implementation of various simulated robotic actions, and to simulate interactions between the simulated robot and the simulated environmental objects in response to the simulated robotic actions. Various simulators can be utilized, such as physics engines that simulates collision detection, soft and rigid body dynamics, etc. One non-limiting example of such a simulator is the BULLET physics engine.

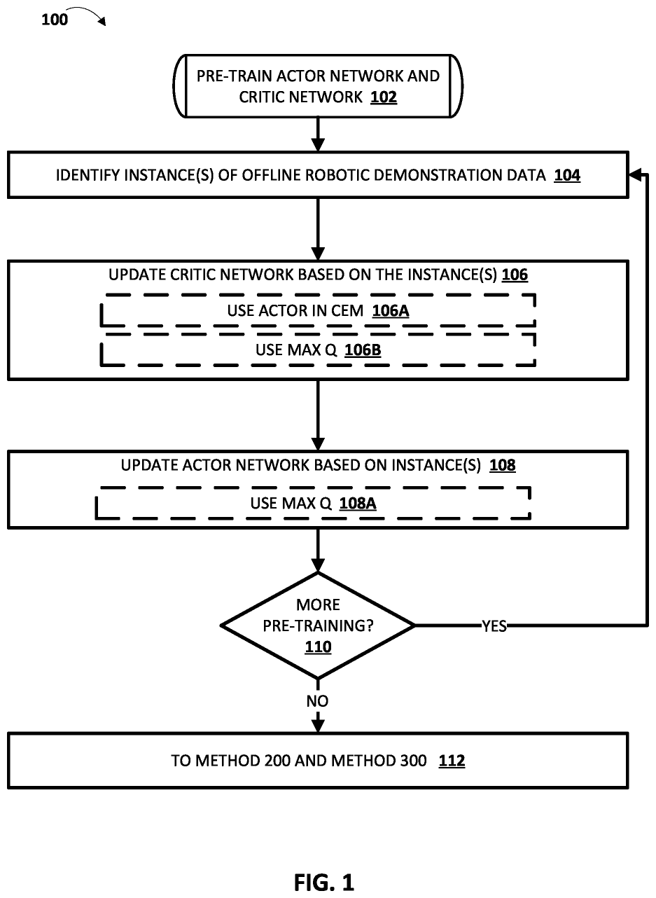

Turning now to the figures, FIG. 1 is a flowchart illustrating an example method 100 of pre-training an actor network and a critic network based on offline demonstration data, according to various implementations disclosed herein. For convenience, the operations of method 100 are described with reference to a system that performs the operations. This system may include one or more components, such as processor(s)) of a robot and/or of computing device(s) (e.g., a cluster of high performance computing devices). Moreover, while operations of method 100 are shown in a particular order, this is not meant to be limiting. One or more operations may be reordered, omitted or added.

At block 102, pre-training of an actor network and a critic network begins. The actor network can be a first neural network model and the critic network can be a separate neural network model. The actor network can be used to process state data to generate output that indicates an action to be taken in view of the state data. The output can be, for example, a probability distribution over an action space. The action to be taken, based on the output of the actor network, can be the highest probability action, optionally subject to one or more rules-based constraints (e.g., safety and/or kinematic constraint(s)). The critic network can be used to process state data and a candidate action, and generate a measure (e.g., a Q-value) that represents the expected discounted reward for taking the candidate robotic action, in view of the state.

At block 104, the system identifies one or more instances of offline robotic demonstration data. For example, the system can identify an instance of offline robotic demonstration data in non-batch pre-training techniques. An instance of offline robotic demonstration data can be obtained, for example, from a replay buffer.

An instance of offline robotic demonstration data can include, for example, an instance of state data, a corresponding robotic action, next state data that is based on the state that results from the corresponding robotic action, and a corresponding reward for the demonstration episode on which the instance is based. In many implementations, the demonstration episodes are all positive demonstrations and, accordingly, the rewards will all be positive rewards, optionally discounted based on discount factor(s) (e.g., a duration of the episode and/or a length of a trajectory of the episode). The demonstration episodes can be, for example, provided by human(s) (e.g., through teleoperation and/or kinesthetic teaching) and/or can be scripted demonstration episodes.

The state data and next state data can include, for example, environmental state data (e.g., image(s) and/or other vision data captured by vision component(s) of a robot) and/or current robot state data (e.g., that indicates a current state of component(s) of the robot). The robotic action can include a representation of movement of one or more robotic component(s). As one example, the robotic action can indicate, in Cartesian space, a translation and/or rotation of an end effector of a robot. As another example, the robotic action can indicate, in joint space, a target joint configuration of one or more robot joints. As yet another example, the robotic action can indicate, in Cartesian space, a direction of movement of a robot base. Additional and/or alternative robotic action spaces can be defined and utilized.

At block 106, the system updates the critic network based on the instance(s). For example, the system can update the critic network utilizing Qt-opt techniques and using CEM and/or other stochastic optimization technique(s). In some implementations, in using CEM, CEM is used in selecting candidate action(s) and processing the candidate action(s), along with next state data, using the critic network. This enables utilization, in training, of generated Q-value(s) for the candidate action(s) with the next state data. This enables taking into account the impact that taking the action will have on the next state (e.g., will the next state provide for the ability to take further action(s) that are “good”).

In some implementations, block 106 includes optional sub-block 106A and/or optional sub-block 106B.

At sub-block 106A, the system uses the actor in CEM. For example, the system can predict an action using the actor network and based on the instance. That action can be processed, along with current state data of the instance, using the critic network, to generate an actor action measure (e.g., Q-value) for the actor action. Further, the current state data and each of multiple candidate actions sampled using CEM, are also processed using the critic network (i.e., N current state data candidate action pairs), to generate a corresponding candidate action measure (e.g., Q-value) for each of the candidate actions. Instead of always using the maximum candidate action measure (e.g., Q-value) from CEM as the maximum value for training of the critic network (and optionally in the advantage function for training of the actor network) as is typical, the system can compare the actor action measure to the maximum candidate action measure—and use the greater of the two measures as the maximum value for training.

At sub-block 106B, the system, instead of utilizing an Expected Q-value, a Max Q-Value can be utilized in training of the critic network, and can also be utilized as part of the advantage-weighted regression training objective in training the actor network (e.g., when it's being trained based on the Positive Sample Filtering referenced above).

At block 108, the system updates the actor network based on the instance(s). In some implementations, the system can update the actor network utilizing an advantage-weighted regression training objective, such as AWAC. In some of those implementations, the advantage-weighted regression training objective utilizes a corresponding Q-value (e.g., a Max Q-value) generated at block 106. For example, as illustrated by optional sub-block 108A of block 108, the training objective can optionally utilize the Max Q-value generated at sub-block 106B.

At block 110, the system determines if more pre-training should occur. This can be based on whether unprocessed demonstration data remains, whether a threshold duration and/or extent of training has occurred, and/or one or more other criteria.

If the decision at block 110 is that more pre-training should occur, the system proceeds back to block 104 and identifies new instance(s) of offline robotic demonstration data.

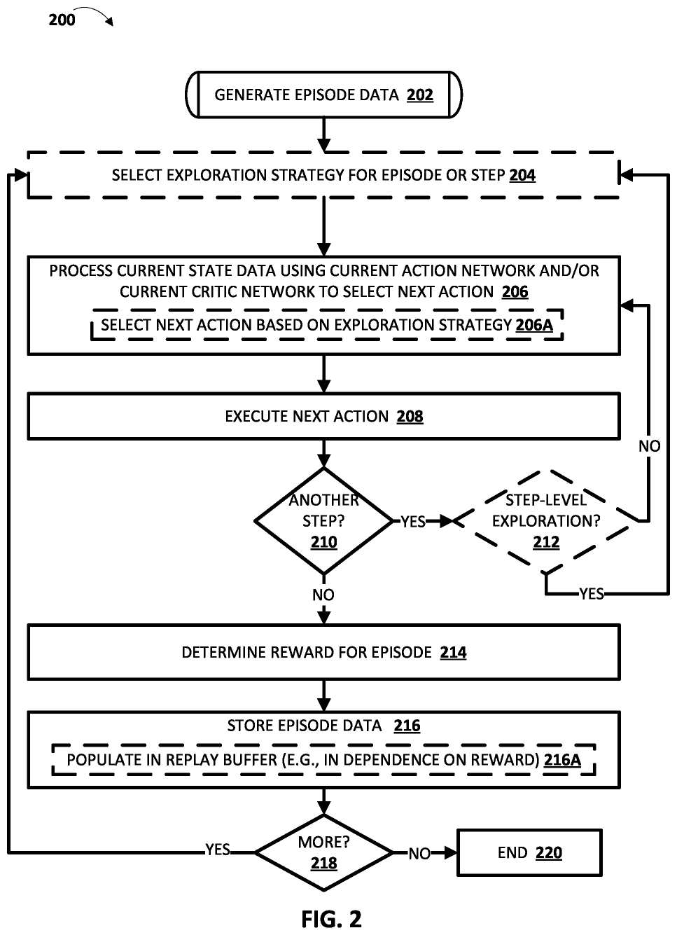

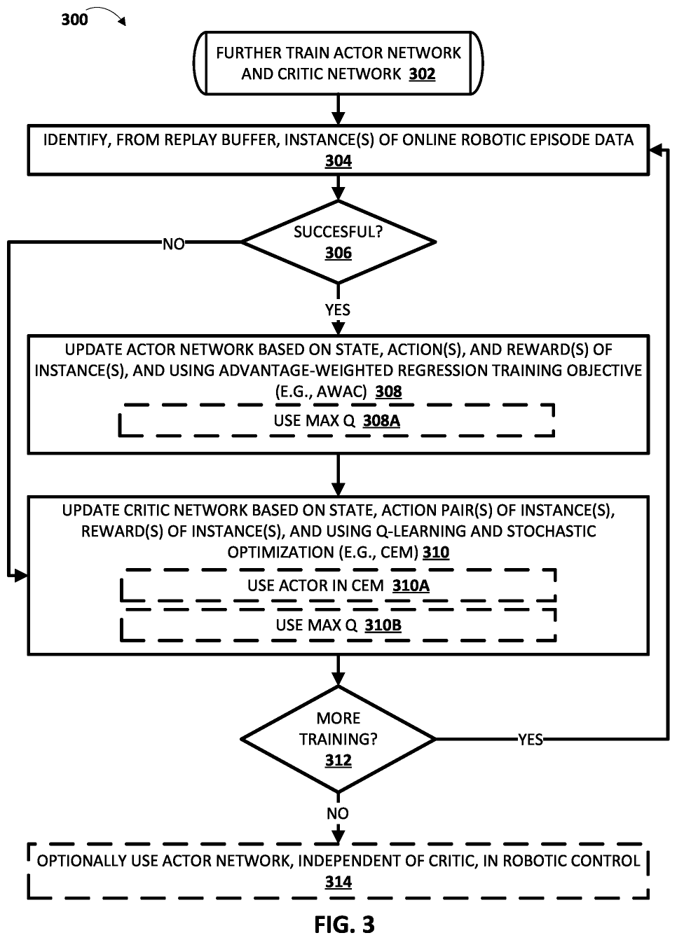

If the decision at block 110 is that pre-training is complete, the system proceeds to block 112. At block 112, the system proceeds to perform method 200 of FIG. 2 and method 300 of FIG. 3. For example, the system can perform method 200 to generate online episode data and simultaneously perform method 300 to further train the actor network and the critic network based on online episode data that is generated based on method 200. Method 200 and 300 are described in more detail below.

FIG. 2 is a flowchart illustrating an example method 200 of generating online episode data, according to various implementations disclosed herein. For convenience, the operations of method 200 are described with reference to a system that performs the operations. This system may include one or more components, such as processor(s)) of a robot and/or of computing device(s) (e.g., a cluster of high performance computing devices). Moreover, while operations of method 200 are shown in a particular order, this is not meant to be limiting. One or more operations may be reordered, omitted or added.

At block 202, generation of episode data begins.

At block 204, the system optionally selects an exploration strategy for an episode or for a step of the episode. For example, with Adaptive Exploration on an episode-by-episode basis, the system can select an exploration strategy for the episode. On the other hand, with Adaptive Exploration on a step-by-step basis, the system can select an exploration strategy for the upcoming step of the episode. The system can select the exploration strategy from amongst two or more exploration strategies such as a CEM policy, a Gaussian policy, and a greedy Gaussian policy. In selecting amongst the exploration strategies, the system can optionally select from amongst them with a probability, and the probabilities amongst exploration policies can differ. For example, a first exploration policy can be selected with an 80% probability and a second with a 20% probability.

At block 206, the system processes current state data, using the current action network and/or the current critic network, to select the next action. At an initial iteration of generating episode data, the current action network and the current critic network can be as pre-trained according to method 100. However, as described herein, in various implementations method 300 can be performed simultaneously with method 200. In such implementations, the actor network and the critic network being utilized in method 200 can be periodically updated based on the further training of method 300. Accordingly, the current critic network and the current actor network can evolve (e.g., at least weights thereof updated) over time during performance of method 200.

Block 206 optionally includes sub-block 206A, in which the system selects the next action based on the exploration strategy, as most recently selected at block 204.

At block 208, the system executes the next action.

At block 210, the system determines whether to perform another step in the episode. Whether to perform another step can be based on the most recently selected next action (e.g., was it a termination action), whether a threshold number of steps have been performed, whether the task is complete, and/or one or more other criteria.

If, at block 210, the system determines to perform another step in the episode, the system proceeds back to block 206 in implementation that don't utilize Adaptive Exploration. In implementations that do utilize Adaptive Exploration, the system proceeds to optional block 212, where the system determines to proceed to block 206 if step-by-step Adaptive Exploration is not being utilized or to instead proceed to block 204 if step-by-step Adaptive Exploration is being utilized.

If, at block 210, the system determines to perform another step in the episode, the system proceeds to block 214 and determines a reward for the episode. The reward can be determined based on a defined reward function, which will be dependent on the robotic task.

At block 216, the system stores episode data from the episode. For example, the system can store various instances of transitions during the episode and a reward for the episode. Each transition can include state data, action, and next state data (i.e., next state data from the next state that resulted from the action). In some implementations, block 216 includes sub-block 216A, in which the system populates some or all of the stored episode data in a replay buffer for use in method 300 of FIG. 3. In some of those implementations, whether the system populates the stored episode data in the replay buffer can depend on whether the reward, for the episode data, is positive—indicating a successful episode (i.e., one in which the robotic task was successfully performed). For example, the system can seek to maintain a certain ratio of successful to unsuccessful episode data in the replay buffer, and can determine whether and/or when to populate episode data in dependence on the ratio (e.g., based on what's currently in the replay buffer and based on whether the episode is successful).

At block 218, the system determines whether to perform more episodes. In some implementations, the system determines whether to perform more episodes based on whether the further training of method 300 is still occurring, whether a threshold quantity of episode data has been generated, whether a threshold duration of episode data generation has occurred, and/or one or more other criteria.

If, at block 218, the system determines to perform more episodes, the system returns to optional block 204 or, if block 204 is not present, to block 206. It is noted that prior to returning to block 206 the robot (e.g., physical or simulated) and/or the environment (e.g., virtual or simulated) can optionally be reset. For example, when a simulator is being used to perform method 200, the starting pose of the robot can be randomly reset and/or the simulated environment adapted (e.g., with new object(s), new lighting condition(s), and/or new object pose(s)—or even a completely new environment). It is also noted that multiple iterations of method 200 can be performed in parallel. For example, iterations of method 200 can be performed across multiple real physical robots and/or across multiple simulators.

FIG. 3 is a flowchart illustrating an example method 300 of further training an actor network and a critic network based on online episode data, according to various implementations disclosed herein. For convenience, the operations of method 300 are described with reference to a system that performs the operations. This system may include one or more components, such as processor(s)) of computing device(s) (e.g., a cluster of high performance computing devices). Moreover, while operations of method 300 are shown in a particular order, this is not meant to be limiting. One or more operations may be reordered, omitted or added.

At block 302, further training of the actor network and the critic network begins.

At optional block 304, the system identifies, from a replay buffer, instance(s) of online robotic episode data. The online robotic episode data can be generated based on method 200 of FIG. 2.

At block 306, the system determines if the instance(s) of episode data are from successful episode(s). If not, the system bypasses updating of the actor network in block 308 (described below). If so, the system does not bypass updating of the actor network in block 308. Accordingly, when optional block 306 is implemented, it can ensure that the actor network is only updated based on episode data from successful episodes.

At block 308, the system updates the actor network based on the instance(s). Block 308 can share one or more (e.g., all) aspects in common with block 108 of FIG. 1, although the episode data on which block 308 is performed is online episode data. Block 308 includes optional sub-block 308A, which can share one or more (e.g., all) aspects in common with block 108A of FIG. 1.

At block 310, the system updates the critic network based on the instance(s). Block 310 can share one or more (e.g., all) aspects in common with block 106 of FIG. 1, although the episode data on which block 310 is performed is online episode data. Block 310 includes optional sub-blocks 310A and 310B, which can share one or more (e.g., all) aspects in common with respective of blocks 106A and 106B of FIG. 1.

At block 312, the system determines if more training should occur. This can be based on whether unprocessed online episode data remains, whether a threshold duration and/or extent of further training has occurred, and/or one or more other criteria.

If the decision at block 312 is that more training should occur, the system proceeds back to block 304 and identifies new instance(s) of online robotic episode data.

If the decision at block 312 is that further training is complete, the system proceeds to block 314.

At block 314, the system can use, or provide for use, at least the actor network in robotic control. In some implementations, the system can use the actor network, independent of the critic network, in robotic control.

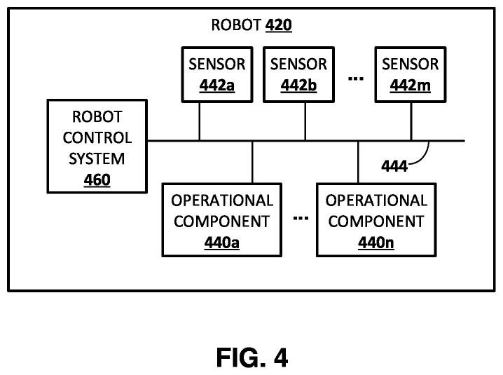

FIG. 4 schematically depicts an example architecture of a robot 420. The robot 420 includes a robot control system 460, one or more operational components 440a-440n, and one or more sensors 442a-442m. The sensors 442a-442m may include, for example, vision sensors, light sensors, pressure sensors, pressure wave sensors (e.g., microphones), proximity sensors, accelerometers, gyroscopes, thermometers, barometers, and so forth. While sensors 442a-m are depicted as being integral with robot 420, this is not meant to be limiting. In some implementations, sensors 442a-m may be located external to robot 420, e.g., as standalone units.

Operational components 440a-440n may include, for example, one or more end effectors and/or one or more servo motors or other actuators to effectuate movement of one or more components of the robot. For example, the robot 420 may have multiple degrees of freedom and each of the actuators may control actuation of the robot 420 within one or more of the degrees of freedom responsive to the control commands. As used herein, the term actuator encompasses a mechanical or electrical device that creates motion (e.g., a motor), in addition to any driver(s) that may be associated with the actuator and that translate received control commands into one or more signals for driving the actuator. Accordingly, providing a control command to an actuator may comprise providing the control command to a driver that translates the control command into appropriate signals for driving an electrical or mechanical device to create desired motion.

The robot control system 460 may be implemented in one or more processors, such as a CPU, GPU, and/or other controller(s) of the robot 420. In some implementations, the robot 420 may comprise a “brain box” that may include all or aspects of the control system 460. For example, the brain box may provide real time bursts of data to the operational components 440a-n, with each of the real time bursts comprising a set of one or more control commands that dictate, inter alia, the parameters of motion (if any) for each of one or more of the operational components 440a-n. The control commands can be based on robotic actions determined utilizing a control policy as described herein. For example, the robotic actions can be determined using an actor network trained according to techniques described herein and, optionally, a critic network trained according to techniques described herein.

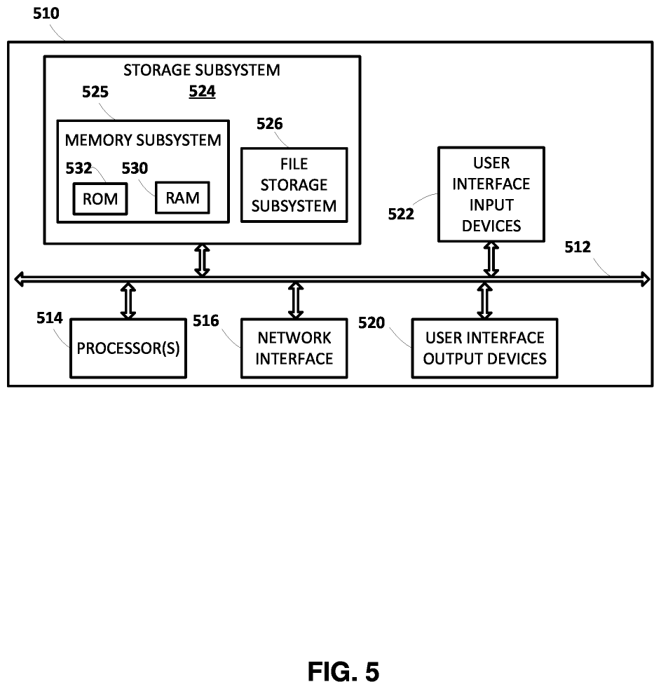

FIG. 5 is a block diagram of an example computing device 510 that may optionally be utilized to perform one or more aspects of techniques described herein. For example, a robotic simulator can be implemented on computing device 510 or in a cluster of multiple computing devices 510 (e.g., high-performance server(s) that may lack certain input and/or output component(s)). As another example, a cluster of multiple computing devices can implement one or more aspects of pre-training and/or further training described herein.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform certain aspects of the method of FIG. 1, the method of FIG. 2, and/or the method of FIG. 3.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

Other implementations may include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described herein. Yet other implementations may include a system of one or more computers and/or one or more robots that include one or more processors operable to execute stored instructions to perform a method such as one or more of the methods described herein.

What is claimed is:

1. A method implemented by one or more processors, the method comprising:
pre-training an actor network and a critic network using reinforcement learning and offline robotic demonstration data from demonstrated robotic episodes, wherein the actor network is a first neural network model that represents a policy, wherein the critic network is a second neural network model that represents a Q-function, and wherein pre-training the actor network and the critic network comprises:
pre-training the actor network using an advantage-weighted regression training objective, the advantage-weighted regression training objective utilizing values generated using the second neural network model, and
pre-training the critic network based on the robotic demonstration data and using Q-learning and a cross-entropy method (CEM),
subsequent to pre-training the actor network and pre-training the critic network:
further training the actor network and the critic network using reinforcement learning and online episode data from robotic episodes each performed based on the actor network and/or the critic network, wherein further training the actor network and the critic network comprises:
further training the actor network based on a first set of the episode data, and using the advantage-weighted regression training objective, and
further training the critic network based on a second set of the episode data, and using Q-learning and the CEM,
wherein the second set includes a given quantity of unsuccessful episode data, that is from unsuccessful episodes of the robotic episodes, and wherein the given quantity is greater than an alternate quantity, of the unsuccessful episode data, that is included in the first set.

2. The method of claim 1, wherein the alternate quantity is zero and wherein the first set includes only successful episode data that is from successful episodes of the robotic episodes.

3. The method of claim 2, wherein the second set includes the successful episode data that is also included in the first set and includes the unsuccessful episode data.

4. The method of claim 1, wherein the alternate quantity, of the unsuccessful episode data, of the first set, is greater than zero, and wherein the unsuccessful episode data of the first set is a subset of the unsuccessful episode data that is included in the second set.

5. The method of claim 4, wherein the ratio of the successful episode data to the unsuccessful episode data, included in the first set, is greater than three to one.

6. The method of claim 5, wherein the ratio of the successful episode data to the unsuccessful episode data, included in the first set, is greater than ten to one.

7. The method of claim 1, further comprising:
generating the first set based on data from the robotic episodes;
generating the second set based on filtering, from the first set, at least a majority of the unsuccessful episode data.

8. The method of claim 7,
wherein generating the first set based on data from the robotic episodes comprises:
populating, over time, a replay buffer with the first set; and
wherein further training the actor network based on the first set comprises sampling the episode data of the first set from the replay buffer.

9. The method of claim 8, wherein populating, over time, the replay buffer with the first set, comprises:
populating the replay buffer with a goal to maintain a particular ratio, of the successful episode data to the unsuccessful episode data, that is in the replay buffer.

10. The method of claim, 1 further comprising:
performing the robotic episodes,
wherein performing each of the robotic episodes comprises:
selecting, from at least a first exploration strategy and a second exploration strategy, a selected exploration strategy for the robotic episode;
determining robotic actions to perform, in the robotic episode, according to the selected exploration strategy.

11. The method of claim 1, further comprising:
performing the robotic episodes,
wherein performing each of the robotic episodes comprises:
for each step of multiple steps of the robotic episode:
selecting, from at least a first exploration strategy and a second exploration strategy, a selected exploration strategy for the step;
determining a robotic action to perform, for the step, according to the selected exploration strategy.

12. The method of claim 11,
wherein the first exploration strategy is a CEM policy in which CEM is performed, using the critic network and sampled actions, and results from the CEM are utilized in selecting an action; and
wherein the second exploration strategy is a greedy Gaussian policy in which a Gaussian probability distribution, generated using the actor network based on a corresponding state and corresponding to candidate actions, is utilized in selecting an action.

13. The method of claim 11, wherein selecting the selected exploration strategy from at least the first exploration strategy and the second exploration strategy comprises:
selecting the first strategy at a first rate and selecting the second strategy at a second rate that is less than the first rate.

14. The method of claim 13, further comprising:
adjusting, the first rate and the second rate after performing at least a threshold quantity of the robotic episodes,
wherein adjusting the first rate and the second rate comprises making the first rate and the second rate closer to one another.

15. The method of claim 1, wherein further training the critic network based on a second set of the episode data comprises, for an instance of the second set of episode data:
processing state data of the instance, using the actor network, to generate actor network output;
selecting an actor action based on the actor network output;
processing the state data and the actor action, using the critic network, to generate an actor action measure for the actor action;
processing the state data and each of multiple candidate actions sampled using CEM, using the critic network, to generate a corresponding candidate action measure for each of the candidate actions;
determining, from amongst the actor action measure and the corresponding candidate action measures, a maximum measure; and
using the maximum measure in training of the critic network.

16. The method of claim 1, wherein further training the critic network based on a second set of the episode data comprises, for an instance of the second set of episode data:
processing state data of the instance, using the actor network, to generate actor network output;
selecting an actor action based on the actor network output;
using the actor action, as an initial mean for CEM in sampling candidate actions;
processing the state data and each of the candidate actions, using the critic network, to generate a corresponding candidate action measure for each of the candidate actions;
determining, from amongst the corresponding candidate action measures, a maximum measure; and
using the maximum measure in training of the critic network.

17. The method of claim 1, further comprising, subsequent to the further training:
using the actor network, independent of the critic network, in autonomous control of a robot.

18. A method implemented by one or more processors, the method comprising:
pre-training an actor network and a critic network using reinforcement learning and robotic demonstration data from demonstrated robotic episodes, wherein the actor network is a first neural network model that represents a policy, wherein the critic network is a second neural network model that represents a Q-function, and wherein pre-training the actor network and the critic network comprises;
pre-training the actor network using an advantage-weighted regression training objective, the advantage-weighted regression training objective utilizing values generated using the second neural network model, and
pre-training the critic network based on the robotic demonstration data and using Q-learning and a cross-entropy method (CEM),
subsequent to pre-training the actor network and pre-training the critic network:
performing online robotic episodes based on the actor network and/or the critic network, wherein performing each of the robotic episodes comprises:
selecting, from at least a first exploration strategy and a second exploration strategy, a selected exploration strategy for:
the robotic episode as a whole, or
each of multiple steps of the robotic episode;
determining robotic actions to perform, in the robotic episode, according to the selecting;
further training the actor network and the critic network using reinforcement learning and online episode data from the robotic episodes, wherein further training the actor network and the critic network comprises:
further training the actor network based on a first set of the episode data, and using the advantage-weighted regression training objective, and
further training the critic network based on a second set of the episode data, and using Q-learning and CEM.

19. The method of claim 18,
wherein the first exploration strategy is a CEM policy in which CEM is performed, using the critic network and sampled actions, and results from the CEM are utilized in selecting an action; and
wherein the second exploration strategy is a greedy Gaussian policy in which a Gaussian probability distribution, generated using the actor network based on a corresponding state and corresponding to candidate actions, is utilized in selecting an action.

20. A method implemented by one or more processors, the method comprising:
pre-training an actor network and a critic network using reinforcement learning and robotic demonstration data from demonstrated robotic episodes, wherein the actor network is a first neural network model that represents a policy, wherein the critic network is a second neural network model that represents a Q-function, and wherein pre-training the actor network and the critic network comprises;
pre-training the actor network using an advantage-weighted regression training objective, the advantage-weighted regression training objective utilizing values generated using the second neural network model, and
pre-training the critic network based on the robotic demonstration data and using Q-learning and a cross-entropy method (CEM),
subsequent to pre-training the actor network and pre-training the critic network:
performing online robotic episodes, wherein performing a given robotic episode;
further training the actor network and the critic network using reinforcement learning and episode data from the robotic episodes, wherein further training the critic network based on a second set of the episode data comprises, for an instance of the second set of episode data:
processing state data of the instance, using the actor network, to generate actor network output;
selecting an actor action based on the actor network output;
processing the state data and the actor action, using the critic network, to generate an actor action measure for the actor action;
processing the state data and each of multiple candidate actions sampled using CEM, using the critic network, to generate a corresponding candidate action measure for each of the candidate actions;
determining, from amongst the actor action measure and the corresponding candidate action measures, a maximum measure; and
using the maximum measure in training of the critic network.
